(19) United States
(12) Patent Application Publication
(10) Pub. No.: US 2014/0373025 A1
(43) Pub. Date: Dec. 18, 2014

(54) METHOD FOR ALLOCATING PROCESS IN MULTI-CORE ENVIRONMENT AND APPARATUS THEREFOR

(71) Applicant: Electronics and Telecommunications Research Institute, Daejeon (KR)

(72) Inventor: Sang Pil KIM, Sejong (KR)

(21) Appl. No.: 14/303,964

(22) Filed: Jun. 13, 2014

(30) Foreign Application Priority Data
Jun. 14, 2013 (KR) 10-2013-0068258

(51) Int. Cl. G06F 9/50

(52) U.S. Cl. CPC G06F 9/5027
USPC 718/104

(57) ABSTRACT

Disclosed are a method for allocating processes and an apparatus for allocating processes. The method may comprise determining a core among the plurality of cores to execute a requested process based on the performance information of the plurality of cores; and allocating the requested process to the determined core. According to the present invention, processes are allocated to cores according to a performance demanded by each of the processes so that processing speed of the processes may be enhanced and power consumption of each of the cores may be reduced.

### CLAIM FOR PRIORITY

This application claims priorities to Korean Patent Application No. 10-2013-0068258 filed on Jun. 14, 2013 in the Korean Intellectual Property Office (KIPO), the entire contents of which are hereby incorporated by references.

### BACKGROUND

1. Technical Field

Example embodiments of the present invention relate to a technique for allocating process in a multi-core environment, and more specifically to a method and apparatus for allocating processes to a plurality of cores having different performances.

2. Related Art

A multi-core environment may generally be classified into a homogeneous multi-core environment using a plurality of cores each of which has identical performance and a heterogeneous multi-core environment using a plurality of cores each of which has difference performance. Here, the plurality of cores which have different performances may mean cores operating at different clock frequencies.

In the multi-core environment, power consumption may be reduced by using multiple cores instead of a single core. However, there may be a problem that it is difficult to allocate a process to an appropriate core according to performances demanded by the process. That is, a process demanding relatively higher performances and a process demanding relatively lower performances may exist among processes. Thus, the advantage of the multi-core environment may not be fully utilized if a process is allocated to an inappropriate core without considering the above situation.

### SUMMARY

Accordingly, example embodiments of the present invention are provided to substantially obviate one or more problems due to limitations and disadvantages of the related art.

Example embodiments of the present invention provide a method for allocating a requested process in a multi-core environment which can allocate the requested process to an appropriate core according to performances demanded by the requested process.

Example embodiments of the present invention also provide an apparatus for allocating a requested process in a multi-core environment which can allocate the requested process to an appropriate core according to performances demanded by the requested process.

In some example embodiments, a method for allocating processes may comprise obtaining performance information of a plurality of cores used to execute processes through monitoring the plurality of cores and storing the performance information; determining a core among the plurality of cores to execute a requested process based on the performance information of the plurality of cores; and providing the requested process to the determined core.

Here, the obtaining performance information of a plurality of cores comprises classifying the plurality of cores into a plurality of core groups based on operation clock frequencies of the plurality of cores; and obtaining the performance information of the plurality of core groups used for executing processes by monitoring the classified core groups.

Here, the determining a core among the plurality of cores to execute a requested process comprises obtaining information about a usage ratio of each of the plurality of cores used for executing a process identical to the requested process; and determining a core having a usage ratio for executing the requested process corresponding to a predefined usage ratio threshold as a core to execute the requested process.

Here, the determining a core having a usage ratio for executing the requested process comprises selecting at least one core having a lower usage ratio for executing the requested process than the predefined usage ratio threshold; and determining a core having a usage ratio nearest to the predefined usage ratio threshold among the selected at least one core as the core to execute the requested process.

Here, the method may further comprise, when the requested process is executed, obtaining information about a usage ratio of the determined core for executing the requested process; and updating the stored performance information of the plurality of cores based on the information about a usage ratio of the determined core.

Here, the plurality of cores may comprise cores operating at different clock frequencies.

Here, the plurality of cores may comprise cores operating based on a same instruction set.

In some example embodiments, an apparatus for allocating processes may comprise a processing part configured to obtain performance information of a plurality of cores used to execute processes through monitoring the plurality of cores, store the performance information of the plurality of cores, determine a core among the plurality of cores to execute a requested process based on the performance information of the plurality of cores, and provide the requested process to the determined core; and a storage part configured to store information processed and being processed in the processing part.

Here, in order to obtain the performance information of the plurality of cores, the processing part may classify the plurality of cores into a plurality of core groups based on operation clock frequencies of the plurality of cores, and obtain the performance information of the plurality of core groups used for executing processes by monitoring the classified core groups.

Here, in order to determine a core to execute the requested process, the processing part may obtain information about a usage ratio of each of the plurality of cores used for executing a process identical to the requested process, and determine a core having a usage ratio for executing the requested process corresponding to a predefined usage ratio threshold as a core to execute the requested process.

Here, in order to determine a core having a usage ratio for executing the requested process corresponding to the predefined usage ratio threshold as the core to execute the requested process, the processing part may select at least one core having a lower usage ratio for executing the requested process than the predefined usage ratio threshold, and determine a core having a usage ratio nearest to the predefined usage ratio threshold among the selected at least one core as the core to execute the requested process.

Here, when the requested process is executed, the processing part may obtain information about a usage ratio of the determined core for executing the requested process, and update the stored performance information of the plurality of cores based on the information about a usage ratio of the determined core.

Here, the plurality of cores may comprise cores operating at different clock frequencies.

Here, the plurality of cores may comprise cores operating based on a same instruction set.

According to the present invention, processes are allocated to cores according to a performance demanded by each of the processes so that processing speed of the processes may be enhanced and power consumption of each of the cores may be reduced.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating an example embodiment in which processes are allocated to cores;

FIG. 2 is a conceptual diagram illustrating another example embodiment in which processes are allocated to cores;

FIG. 3 is a flow chart illustrating a method for allocating processes according to an example embodiment of the present invention;

FIG. 4 is a flow chart illustrating a step 100 of obtaining performance information of a plurality of cores in the method for allocating processes according to an example embodiment of the present invention;

FIG. 5 is a flow chart illustrating a step S200 of determining a core among the plurality of cores to execute a requested process in the method for allocating process according to an example embodiment of the present invention; and

FIG. 6 is a block diagram illustrating an apparatus for allocating processes according to an example embodiment of the present invention.

### DESCRIPTION OF EXAMPLE EMBODIMENTS

Example embodiments of the present invention are disclosed herein. However, specific structural and functional detail disclosed herein are merely representative for purposes of describing example embodiments of the present invention, however, example embodiments of the present invention may be embodied in many alternate forms and should not be construed as limited to example embodiments of the present invention set forth herein. Accordingly, while tie invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that when an element is referred to as being “on” or “below” another element, it can be directly on another element or intervening elements may be present.

It will be understood that, although the terms first, second, A, B, etc. may be used herein to describe various elements, these elements should not be limited by these terms. These terms are only used to distinguish one element from another. For example, a first element could be termed a second element, and similarly, a second element could be termed a first element, without departing from the scope of the present invention. As used here, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described in detail with reference to the appended drawings. In the following description, for easy understanding, like numbers refer to like elements throughout the description of the figures regardless of number of the figures.

In the whole specification, a multi-core environment means a homogeneous multi-core environment using a plurality of cores each of which has identical performance, or a heterogeneous multi-core environment using a plurality of cores each of which has difference performance. Here, the plurality of cores each of which has different performance mean cores operating at different clock frequencies.

A process is an instance of a computer program that is being executed.

A performance of a core means a performance of the core required to execute a specific process. That is, the performance of the core means a usage ratio of the core for executing the specific process, and performance information of the core means information about the performance of the core. For example, a core having a high performance means a core whose usage ratio required for executing a process is low, and a core having a low performance means a core whose usage ratio required for executing the same process is high. For example, when 78% of the full capability of the core A, 91% of the full capability of the core B, and 100% of the full capability of the core C should be used for executing the process 0, the core A may be referred to as a core having the highest performance, and the core C may be referred to as a core having the lowest performance. Also, the core B may be referred to as a core having a performance lower than the core A and higher than the core C.

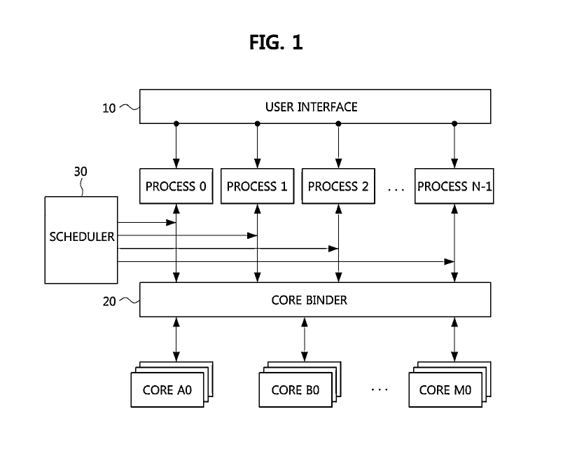

FIG. 1 is a conceptual diagram illustrating an example embodiment in which processes are allocated to cores.

Referring to FIG. 1, a plurality of processes (a process 0, a process 1, a process 2, . . . , and a process N−1) may be generated by a user interface 10, and allocated to multiple cores (a core A0, a core B0, . . . , and a core M0) by a scheduler 30. Also, a core binder 20 may provide the plurality of processes to the plurality of cores based on the result of allocation performed by the scheduler 30.

Here, the multiple cores (the core A0, the core B0, . . . , and the core M0) may mean cores having an identical performance (for example, they operate at the same clock frequency), and the scheduler 30 may allocate the plurality of processes (the process 0, the process 1, the process 2, . . . , and the process N−1) to the multiple cores in sequential manner. In other words, when a process is generated by the user interface 10, the scheduler 30 allocates the newly generated process to a currently-available core in the sequential manner. For example, when the process 0 is generated, the scheduler may allocate the process 0 to the core A0. Also, when the process 1 is generated, the scheduler may allocate the process 1 to the core B0.

In the above-described method, processes are allocated to cores sequentially according to orders of their generation even when performances demanded for each process are different. Thus, there may be a problem that a characteristic of multi-core environment cannot be efficiently utilized. That is, even though processes may be classified into a process demanding relatively higher performances and a process demanding relatively lower performances, a requested process cannot be allocated to an appropriate core according to the property of the requested process in a multi-core environment comprising a plurality of cores which have identical performances. For example, in case of a process demanding relatively higher performances, if it is allocated to a relatively low-performance core, the execution of it may be delayed. On the contrary, in case of a process demanding relatively lower performances, if it is allocated to a relatively high-performance core, large energy may be consumed unnecessarily.

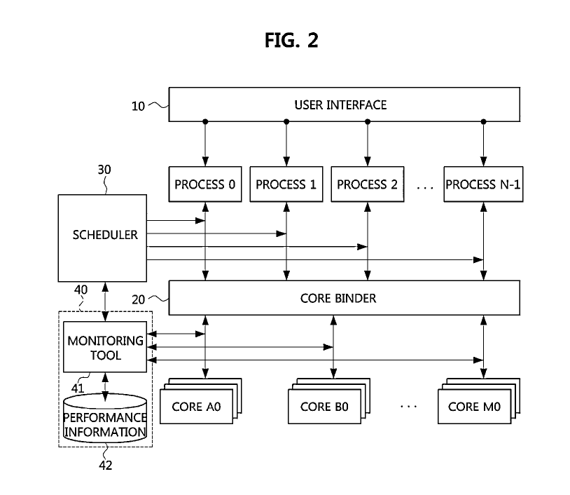

FIG. 2 is a conceptual diagram illustrating another example embodiment in which processes are allocated to cores.

Referring to FIG. 2, a plurality of processes (a process 0, a process 1, a process 2, . . . , and a process N−1) may be generated by a user interface 10. A monitoring part 40 may obtain performance information of each core (or, each core group) by using a monitoring tool 41, and provide the obtained information to a scheduler 30.

The scheduler 30 may allocate the plurality of processes (the process 0, the process 1, the process 2, . . . , and the process N−1) to multiple cores (a core A0, a core B0, . . . , and a core M0) based on the performance information of each core. Also, the core binder 20 may provide the plurality of processes to the plurality of cores based on the result of allocation performed by the scheduler 30.

Here, the multiple cores (the core A0, the core B0, . . . , and the core M0) may mean cores having different performances (for example, they operate at different clock frequencies), and the scheduler 30 may allocate the plurality of processes (the process 0, the process 1, the process 2, . . . , and the process N−1) to the multiple cores based on the performance information of each core not in the sequential manner.

For example, when the process 0 is generated by the user interface 10, if the performance of the core B0 is optimal for the process 0 (for example, if the process 0 can be executed by using about 80% of the full capability of the cored B0), the scheduler 30 may allocate the process 0 to the core B0. Also, when the process 1 is generated by the user interface 10, if the performance of the core A0 is optimal for the process 1 (for example, if the process 1 can be executed by using about 80% of the full capability of the cored A0), the scheduler 30 may allocate the process 1 to the core A0. In the above example, the predefined threshold (for example, 80%) may be configured variably according to the example embodiments.

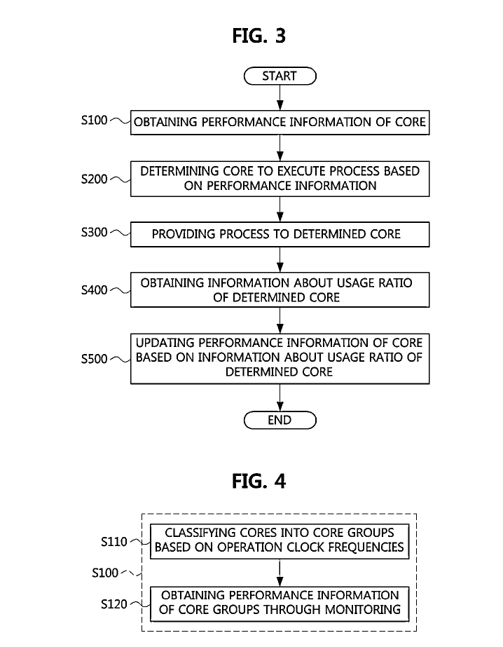

FIG. 3 is a flow chart illustrating a method for allocating processes according to an example embodiment of the present invention.

Referring to FIG. 3, a method for allocating processes according to an example embodiment of the present invention may comprise a step S100 of obtaining performance information of a plurality of cores used to execute processes through monitoring the plurality of cores and storing the performance information, a step S200 of determining a core among the plurality of cores to execute a requested process based on the performance information of the plurality of cores, and a step S300 of allocating the requested process to the determined core.

Additionally, the method may further comprise a step S400 of obtaining performance information of the determined core when the requested process is executed by the determined core, and a step S500 of updating the stored performance information of the plurality of cores based on the obtained performance information of the determined core.

The multiple cores may comprise a plurality of cores having difference performances. That is, the multiple cores may be configured as cores having different operation clock frequencies, and the cores may operate based on the same instruction set.

The performance information of the plurality of cores means information about performances of the plurality of cores for executing a plurality of processes, and the performance information of the determined core means performance information of the core allocated to the requested process. For example, the performance of the core A means a usage ratio of the core A required for executing the process 0, a usage ratio of the core A required for executing the process 1, or a usage ratio of the core A required for executing the process 2. On the other hand, the performance information of the core A includes performance of the core A for the process 0, performance of the core A for the process 1, and performance of the core A for the process 2.

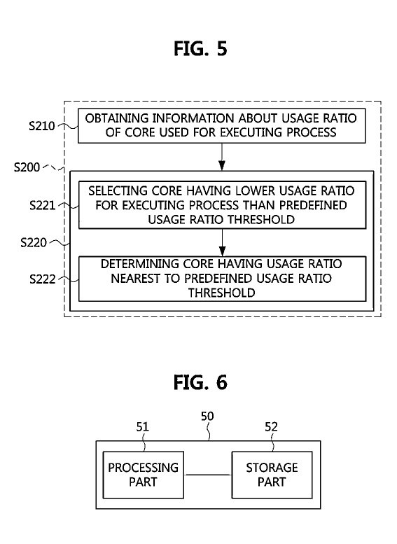

Here, each step of the method for allocating processes may be performed in an apparatus for allocating processes which will be illustrated in FIG. 6, and the apparatus for allocating processes may be a part or a whole part of a specific terminal device.

Here, a desktop computer, laptop computer, tablet PC, wireless phone, mobile phone, smartphone, e-book reader, portable multimedia player (PMP), portable game console, navigation device, digital camera, digital multimedia broadcasting (DMB) player, digital audio recorder, digital audio player, digital picture recorder, digital picture player, digital video recorder, or digital video player may be used as the terminal.

The apparatus for allocating processes may obtain performance information of a plurality of cores used to execute processes through monitoring the plurality of cores (S100). Also, the apparatus may store the obtained information in a database, and use the stored performance information in order to allocate processes requested later.

For example, when the multiple cores comprise the core A, the core B, and the core B each of which has different performance and the process 0, the process 2, and the process 3 are executed by the multiple cores, the apparatus for allocating processes may obtain performance information of the plurality of cores used to execute processes as represented in a below table 1.

TABLE 1

| | Core A | Core B | Core C |
|---|---|---|---|
| Process 0 | 78% | 91% | 100% |
| Process 1 | 24% | 52% | 83% |
| Process 2 | 10% | 30% | 50% |
| Process 3 | 50% | 70% | 90% |

Here, the core A is a core having the best capability (that is, a core having the highest operation clock frequency), and the core B is a core having the worse capability than the core A, and the core C is a core having the worst capability (that is, having the lowest operation clock frequency).

In case of the core A, the usage ratio of the core A required for executing the process 0, 1, 2, or 3 is respectively 78%, 24%, 10%, or 50% of the full capability of the core A.

Also, in case of the core B, the usage ratio of the core B required for executing the process 0, 1, 2, or 3 is respectively 91%, 52%, 30%, or 70% of the full capability of the core B.

Also, in case of the core C, the usage ratio of the core C required for executing the process 0, 1, 2, or 3 is respectively 100%, 83%, 50%, or 90% of the full capability of the core C.

Here, the usage ratio of the core C which is required for executing the process 0 is 100% of the full capability of the core C. This means that the performance of the core C is low to execute the process 0 so that a processing delay may occur when the core C is allocated to execute the process 0.

FIG. 4 is a flow chart illustrating a step 100 of obtaining performance information of a plurality of cores in the method for allocating processes according to an example embodiment of the present invention.

Referring to FIG. 4, the apparatus for allocating processes may classify the plurality of cores into several core groups based on operation clock frequencies of the plurality of cores (S110), and may obtain performance information of each core group for executing processes by monitoring the classified core groups (S120).

For example, if the multiple cores comprise cores having 2.5 GHz operation clock frequency, cores having 2 GHz operation clock frequency, and cores having 1.5 GHz operation clock frequency, the apparatus for allocating process may classify the multiple cores into a core group A including the cores having 2.5 GHz operation clock frequency, a core group B including the cores having 2 GHz operation clock frequency, and a core group C including the cores having 1.5 GHz operation clock frequency.

In order to obtain the performance information of each core group, the apparatus for allocating processes may use performance information of a core included in each core group as the performance information of the core group. Alternatively, the apparatus may use an average value of performances of some cores included in each core group as the performance information of the core group. Alternatively, the apparatus may obtain an average value of performances of all cores included in each core group as the performance information of the core group.

FIG. 5 is a flow chart illustrating a step S200 of determining a core among the plurality of cores to execute a requested process in the method for allocating process according to an example embodiment of the present invention.

Referring to FIG. 5, the apparatus for allocating processes may obtain performance of each core required for executing the requested process based on the collected performance information (S210), and determine a core having a performance satisfying predefined criteria as a core will execute the requested process (S220). For example, in the case of the above table 1, when the apparatus is requested to execute the process 0, the apparatus may obtain performance information of each core required for executing the process 0 or a process identical to the process 0 (that is, the core A: 78%, the core B: 91%, and the core C: 100%) based on the performance information collected in the step S100. Also, when the apparatus is requested to execute the process 1, the apparatus may obtain performance information of each core required for executing the process 1 or a process identical to the process 1 (that is, the core A: 24%, the core B: 52%, and the core C: 83%) based on the performance information collected in the step S100. Through a procedure similar to the above-described procedure, the apparatus may obtain performance information of each core required for executing the process 2 and the process 3.

Also, the apparatus may obtain performance of each core group required for executing a process identical to the requested process based on the collected performance information of each core group.

In the step S220, the apparatus may select at least one core having a lower usage ratio required for executing the requested process than a predefined threshold (S221), and determine a core having a usage ratio nearest to the predefined threshold among the at least one core as a core to execute the requested process (S222).

For example, in the case of the above table 1, if the predefined threshold (that is, a usage ratio required for executing the requested process) is 80%, the apparatus may select the core A, and determine the core A having a usage ratio nearest to the predefined threshold required for executing the process 0 as a core to execute the process 0.

In the case of the process 1, the apparatus may select the core A and the core B (that is, cores having a lower usage ratio required for executing the process 1 than the predefined threshold), and determine the core B having a usage ratio nearest to the predefined threshold required for executing the process 1 as a core to execute the process 1.

In the case of the process 2, the apparatus for allocating process may select the core A, the core B, and the core C (that is, cores having a lower usage ratio required for executing the process 1 than the predefined threshold), and determine the core C having a usage ratio nearest to the predefined threshold required for executing the process 2 as a core to execute the process 2.

In the case of the process 3, the apparatus may select the core A and the core B (that is, cores having a lower usage ratio required for executing the process 3 than the predefined threshold), and determine the core B having a usage ratio nearest to the predefined threshold required for executing the process 3 as a core to execute the process 3.

The following table 2 represents cores determined through the above-described procedure.

TABLE 2

| | Core A | Core B | Core C | Allocated core |
|---|---|---|---|---|
| Process 0 | 78% | 91% | 100% | Core A |
| | | | (delay may occur) | |
| Process 1 | 24% | 52% | 83% | Core B |
| Process 2 | 10% | 30% | 50% | Core C |
| Process 3 | 50% | 70% | 90% | Core B |

Also, the apparatus for allocating processes may select at least one core group having a lower usage ratio required for executing the requested process based on the performance information, and determine a core group having a usage ratio nearest to the predefined threshold for executing the requested process among the at least one core group as a core group to execute the requested process.

Re-referring to FIG. 3, at the step S300, the apparatus for allocating processes may provide the requested process to the core or the core group determined in the step S200.

For example, in the case of the above table 2, the apparatus may provide the process 0 to the core A, the process 1 to the core B, the process 2 to the core C, and the process 3 to the core B. In this case, the apparatus may instruct the core binder 20 to provide each process to the corresponding core, and the core binder 20 may provide each process to the each corresponding core based on the instruction.

In addition, the apparatus may obtain information about a usage ratio of each core (or, each core group) when the requested process is executed by each core or each core group (S400), and then update the performance information of each core or each core group based on the obtained information (S500).

For example, when the processes are allocated to cores as shown in the table 2, the apparatus may obtain information on a usage ratio of the core A required for executing the process 0, and update the performance information of the core A (that is, information on a performance ratio of the core A required for the process 0) based on the obtained information. Also, the apparatus may obtain information on a usage ratio of the core B required for executing the process 1, and update the performance information of the core B (that is, information on a usage ratio of the core B required for the process 1) based on the obtained information. Also, the apparatus may obtain information on a usage ratio of the core C required for executing the process 2, and update the performance information of the core C (that is, information on a usage ratio of the core C required for the process 2) based on the obtained information. Also, the apparatus may obtain information on a usage ratio of the core B required for executing the process 3, and update the performance information of the core B (that is, information on a usage ratio of the core B required for the process 3) based on the obtained information.

The following table 3 represents results of process allocation according to the present invention, and the following table 4 represents results of process allocation according to the conventional method (that is, a sequential allocation method.)

TABLE 3

| | Core A | Core B | Core C | Core Status |
|---|---|---|---|---|
| Process 0 | 78% | — | — | Delay does not occur |
| Process 1 | — | 52% | — | Delay does not occur |
| Process 2 | — | — | 50% | Delay does not occur |
| Process 3 | — | 70% | — | Delay does not occur |

TABLE 4

| | Core A | Core B | Core C | Core Status |
|---|---|---|---|---|
| Process 0 | — | — | 100% | Delay occurs |
| | | | (delay) | |
| Process 1 | 24% | — | — | Energy wasted |
| Process 2 | — | 30% | — | Energy wasted |
| Process 3 | — | — | 90% | Delay may occur with high |
| | | | | probability |

Referring to the tables 3 and 4, in the case of the process 0, the process 0 may be allocated to the core C according to the conventional method, and there may be a problem that the process 0 is delayed as compared with the method according to the present invention. The process 1 may be allocated to the core A according to the conventional method. In this case, there may be a problem that energy is unnecessarily wasted as compared with the case of the method according to the present invention. Also, the process 2 may be allocated to the core B according to the conventional method. In this case, there may be a problem that energy is unnecessarily wasted as compared with the case of the method according to the present invention. On the other hand, the process 3 may be allocated to the core C according to the conventional method. In this case, there may be a problem that a processing delay may occur with a high probability since the performance of the core C is too low to execute the process 3.

A method for allocating processes according to the example embodiment or the other example embodiment of the present invention can be implemented in the form of a program command that can be executed through a variety of computer means and recorded in a computer-readable medium. The computer-readable medium may include program commands, data files, data structures, etc. in a single or combined form. The program commands recorded in the computer-readable medium may be program commands that are specially designed and configured for the example embodiments of the present invention, or program commands that are publicized and available for those of ordinary skill in the art of computer software.

Examples of the computer-readable medium include hardware devices, such as a read-only memory (ROM), a random access memory (RAM), and a flash memory, specially configured to store and execute program commands. Examples of the program commands include advanced language codes that can be executed by a computer using an interpreter, etc., as well as machine language codes, such as those generated by a compiler. The hardware devices may be configured to operate as at least one software module so as to perform operations of the example embodiments of the present invention, and vice versa.

FIG. 6 is a block diagram illustrating an apparatus for allocating processes according to an example embodiment of the present invention.

Referring to FIG. 6, the apparatus for allocating process 50 may comprise a processing part 51 and a storage part 52. The processing part 51 may obtain information about performances of a plurality of cores used to execute processes through monitoring the plurality of cores, determine a core among the plurality of cores to execute a requested process based on the information about performances of the plurality of cores, and allocate the requested process to the determined core.

Here, the plurality of cores may comprise cores having difference performances. That is, the plurality of cores may be configured with cores having different operation clock frequencies, and they may operate based on the same instruction set.

The processing part 51 may perform monitoring on the plurality of cores, and then obtain information about performances of the plurality of cores used for executing processes as shown in the table 1. Also, the processing part 51 may build a database storing the obtained information, and use the information about performances of the plurality of cores stored in the database to execute a process which is requested to be executed later.

The processing part 51 may classify the plurality of cores into several core groups based on operation clock frequencies of the plurality of cores, and may obtain performance information of each group about performances required for executing processes by monitoring the classified core groups.

For example, if the multiple cores comprise cores having 2.5 GHz operating clock frequency, cores having 2 GHz operating clock frequency, and cores having 1.5 GHz operating clock frequency, the apparatus for allocating process may classify the multiple cores into a core group A including the cores having 2.5 GHz operating clock frequency, a core group B including the cores having 2 GHz operating clock frequency, and a core group C including the cores having 1.5 GHz operating clock frequency.

In order to obtain the performance information of each group, the processing part 51 may obtain performance of a core included in each core group as the performance information of the core group. Alternatively, the processing part 51 may obtain an average value of performances of some cores included in each core group as the performance information of the core group. Alternatively, the processing part 51 may obtain an average value of performances of all cores included in each core group as the performance information of the core group.

In order to determine a core to execute the requested process, the processing part 51 may obtain performance of each core required for executing the requested process based on the collected performance information, and determine a core having a performance satisfying predefined criteria as a core will execute the requested process.

For example, in the case of the above table 1, when the processing part 51 is requested to execute the process 0, the processing part 51 may obtain information on performance of each core required for executing the process 0 or a process identical to the process 0 (that is, the core A: 78%, the core B: 91%, and the core C: 100%.) Also, when the processing part 51 is requested to execute the process 1, the processing part 51 may obtain information on performance of each core required for executing the process 1 or a process identical to the process 1 (that is, the core A: 24%, the core B: 52%, and the core C: 83%.) Through a procedure similar to the above-described procedure, the processing part 51 may obtain information on performance of each core required for executing the process 2 and the process 3.

Also, the processing part 51 may obtain performance of each core group required for executing a process identical to the requested process based on the collected performance information of each core group.

The processing part 51 may select at least one core having a lower usage ratio required for executing the requested process than a predefined threshold, and determine a core having a usage ratio nearest to the predefined threshold among the at least one core as a core to execute the requested process.

For example, in the case of the above table 1, if the predefined threshold (that is, a ratio of performance required for executing the requested process) is 80%, the processing part 51 may select the core A, and determined the core A having the nearest performance ratio required for executing the process 0 as a core to execute the process 0. Similarly, the processing part 51 may determine the core B as a core to execute the process 1, the core C as a core to execute the process 2, and the cored B as a core to execute the process 3.

The processing part 51 may provide the requested process to the determined core or core group.

For example, in the case of the above table 2, the apparatus for allocating process may provide the process 0 to the core A, the process 1 to the core B, the process 2 to the core C, and the process 3 to the core B. In this case, the apparatus may instruct the core binder 20 to provide each process to the corresponding core, and the core binder 20 may provide each process to the each corresponding core based on the instruction.

For example, in the case of the above table 2, the processing part 51 may provide the process 0 to the core A, the process 1 to the core B, the process 2 to the core C, and the process 3 to the core B. In this case, the processing part 51 may instruct the core binder 20 to provide each process to the corresponding core, and the core binder 20 may provide each process to the each corresponding core based on the instruction.

In addition, the processing part 51 may obtain information about a performance ratio of each core (or, each core group) when the requested process is executed by each core or each core group, and then update the performance information of each core or each core group based on the obtained information.

For example, when the processes are allocated to cores as shown in the table 2, the processing part 51 may obtain information on a performance ratio of the core A required for executing the process 0, and update the performance information of the core A (that is, information on a performance ratio of the core A required for the process 0) based on the obtained information. Similarly, the processing part 51 may update the performance information of the core B for the process 1, the performance information of the core C for the process 2, and the performance information of the core B for the process 3.

The storage part 52 may store information processed and being processed in the processing part. That is, the storage part 52 may store performance information of each core (or, each core group), information on allocation of each process, the predefined threshold, and the predefined usage ratio.

Here, the processing part 51 may comprise a processor and a memory. The processor may be a general-purpose processer (for example, a central processing unit (CPU) and/or a graphics processing unit (GPU)), or a dedicated processor designed for performing the method for allocating process. The memory may store a program code for executing the method for allocating process. That is, the processor may read out the stored program code from the memory, and execute each step of the method based on the program code.

While the example embodiments of the present invention and their advantages have been described in detail, it should be understood that various changes, substitutions and alterations may be made herein without departing from the scope of the invention.

What is claimed is:

1. A method for allocating processes, the method comprising:
obtaining performance information of a plurality of cores used to execute processes through monitoring the plurality of cores and storing the performance information;
determining a core among the plurality of cores to execute a requested process based on the performance information of the plurality of cores; and
providing the requested process to the determined core.

2. The method of claim 1, wherein the obtaining performance information of a plurality of cores comprises:
classifying the plurality of cores into a plurality of core groups based on operation clock frequencies of the plurality of cores; and
obtaining the performance information of the plurality of core groups used for executing processes by monitoring the classified core groups.

3. The method of claim 1, wherein the determining a core among the plurality of cores to execute a requested process comprises:
obtaining information about a usage ratio of each of the plurality of cores used for executing a process identical to the requested process; and
determining a core having a usage ratio for executing the requested process corresponding to a predefined usage ratio threshold as the core to execute the requested process.

4. The method of claim 3, wherein the determining a core having a usage ratio for executing the requested process comprises:
selecting at least one core having a lower usage ratio for executing the requested process than the predefined usage ratio threshold; and
determining a core having a usage ratio nearest to the predefined usage ratio threshold among the selected at least one core as the core to execute the requested process.

5. The method of claim 1, further comprising:
when the requested process is executed, obtaining information about a usage ratio of the determined core for executing the requested process; and
updating the stored performance information of the plurality of cores based on the information about a usage ratio of the determined core.

6. The method of claim 1, wherein the plurality of cores comprise cores operating at different clock frequencies.

7. The method of claim 1, wherein the plurality of cores comprise cores operating based on a same instruction set.

8. An apparatus for allocating processes, the apparatus comprising:
a processing part configured to obtain performance information of a plurality of cores used to execute processes through monitoring the plurality of cores, store the performance information of the plurality of cores, determine a core among the plurality of cores to execute a requested process based on the performance information of the plurality of cores, and provide the requested process to the determined core; and
a storage part configured to store information processed and being processed in the processing part.

9. The apparatus of claim 8, wherein the processing part, in order to obtain the performance information of the plurality of cores, classifies the plurality of cores into a plurality of core groups based on operation clock frequencies of the plurality of cores, and obtains the performance information of the plurality of core groups used for executing processes by monitoring the classified core groups.

10. The apparatus of claim 8, wherein the processing part, in order to determine a core to execute the requested process, obtains information about a usage ratio of each of the plurality of cores used for executing a process identical to the requested process, and determines a core having a usage ratio for executing the requested process corresponding to a predefined usage ratio threshold as the core to execute the requested process.

11. The apparatus of claim 10, wherein the processing part, in order to determine a core having a usage ratio for executing the requested process corresponding to the predefined usage ratio threshold as the core to execute the requested process, selects at least one core having a lower usage ratio for executing the requested process than the predefined usage ratio threshold, and determines a core having a usage ratio nearest to the predefined usage ratio threshold among the selected at least one core as the core to execute the requested process.

12. The apparatus of claim 8, wherein, when the requested process is executed, the processing part obtains information about a usage ratio of the determined core for executing the requested process, and updates the stored performance information of the plurality of cores based on the information about a usage ratio of the determined core.

13. The apparatus of claim 8, wherein the plurality of cores comprise cores operating at different clock frequencies.

14. The apparatus of claim 8, wherein the plurality of cores comprise cores operating based on a same instruction set.
